(19) United States
(12) Patent Application Publication
(10) Pub. No.: US 2012/0027385 A1
(43) Pub. Date: Feb. 2, 2012

(54) PROGRAM RECORDER, PROGRAM RECORDING MANAGEMENT SYSTEM, AND RECORDED PROGRAM MANAGING METHOD

(75) Inventors: Toshihiro Morohoshi, Kawasaki-shi (JP); Kiyoshi Hoshino, Ome-shi (JP); Hideo Kataoka, Tokyo (JP)

(73) Assignee: KABUSHIKI KAISHA TOSHIBA, Tokyo (JP)

(21) Appl. No.: 13/188,209

(22) Filed: Jul. 21, 2011

(30) Foreign Application Priority Data
Jul. 30, 2010 (JP) 2010-172757

(51) Int. Cl. H04N 5/76

(52) U.S. Cl. 386/291

(57) ABSTRACT

According to one embodiment, a recording management system including, a retaining module configured to independently retain, information on a program recorded by a first recorder and information on a program recorded by a second recorder independent of the first recorder, a list creating module configured to create a combined recorded program list, the combined recorded program list including a combination of the information on the program recorded by the first recorder and the information on the program recorded by the second recorder that are retained by the retaining module, and a managing module configured to create a list of the programs reproducible by a reproducer from the combined recorded program list retained by the list creating module in response to a request from the reproducer for the list of the programs reproducible by this reproducer, the managing module sending back the generated reproducible program list to the reproducer.

### CROSS-REFERENCE TO RELATED APPLICATIONS

This application is based upon and claims the benefit of priority from Japanese Patent Application No. 2010-172757, filed Jul. 30, 2010; the entire contents of which are incorporated herein by reference.

### FIELD

Embodiments described herein relate generally to a program recorder, a program recording management system, and a recorded program managing method, wherein whether a recorded program retained in the program recorder can be reproduced by a reproducer can be checked by the reproducer.

### BACKGROUND

It is often the case that, for example, a household owns more than one program recorder for recording programs and more than one television receiver (television set) having a recording function.

When there is more than one program recorder, the same program may be recorded by two or more program recorders.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a system according to an embodiment;

FIG. 2 is an exemplary diagram showing an example of a reservation according to an embodiment;

FIG. 3 is an exemplary diagram showing an example of a reservation according to an embodiment;

FIG. 4 is an exemplary diagram showing an example of a reservation according to an embodiment;

FIG. 5 is an exemplary diagram showing an example of a reservation according to an embodiment;

FIG. 6 is an exemplary diagram showing an example of indications according to an embodiment;

FIG. 7A is an exemplary diagram showing an example of a system according to an embodiment;

FIG. 7B is an exemplary diagram showing an example of a system according to an embodiment;

FIG. 8 is an exemplary diagram showing an example of indications of device information according to an embodiment;

FIG. 9A is an exemplary diagram showing an example of an analysis of received information according to an embodiment;

FIG. 9B is an exemplary diagram showing an example of an analysis of received information according to an embodiment;

FIG. 10 is an exemplary diagram showing an example of a recorded program list according to an embodiment;

FIG. 11 is an exemplary diagram showing an example of a recorded program list according to an embodiment;

FIG. 12 is an exemplary diagram showing an example of a terminal device for use in the system according to an embodiment; and

FIG. 13 is an exemplary diagram showing an example of a system according to an embodiment.

### DETAILED DESCRIPTION

Various embodiments will be described hereinafter with reference to the accompanying drawings. In general, according to one embodiment, a recording management system comprising: a retaining module configured to independently retain, information on a program recorded by a first recorder and information on a program recorded by a second recorder independent of the first recorder; a list creating module configured to create a combined recorded program list, the combined recorded program list including a combination of the information on the program recorded by the first recorder and the information on the program recorded by the second recorder that are retained by the retaining module; and a managing module configured to create a list of the programs reproducible by a reproducer from the combined recorded program list retained by the list creating module in response to a request from the reproducer for the list of the programs reproducible by this reproducer, the managing module sending back the generated reproducible program list to the reproducer.

Embodiments will now be described hereinafter in detail with reference to the accompanying drawings.

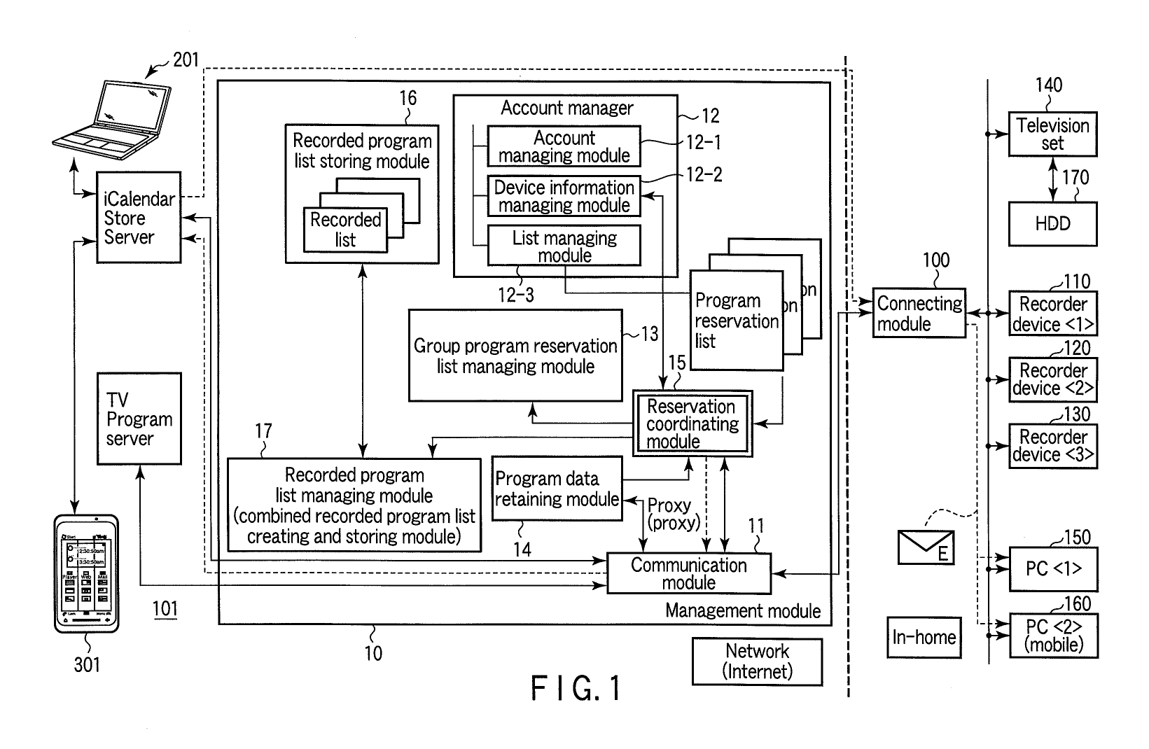

FIG. 1 shows an example of a program recorder according to an embodiment. It is to be noted that elements and/or components or elements referred to as “module” described below may be obtained by hardware or may be obtained by software using, for example, a microcomputer (processor or CPU).

A program recording management system 101 shown in FIG. 1 includes at least a given number of program recorders (group), a management module 10, and a connecting module 100. The program recorders (group) are typically used by a single user or within a household (or within the same subscription), and are prepared in a closed network that is permitted to reproduce a program mutually. The management module 10 retains recorded programs and recording reservation status of the respective program recorders (group), and is capable of control through the network, for example, setting of an additional recording reservation. The connecting module 100 is responsible for passing (sending/receiving or inputting/outputting) content (which may be referred to as a program or a title) and control signals between the management module 10 and the program recorders (group).

The connecting module 100 connects the network (Internet) to which the management module 10 is connected and an in-home network to which the program recorders (group) are connected. In general, a device called a router is used as the connecting module 100.

The above-described program recorder (an example of which will be shown below) or a personal computer (PC) owned by a user can be set as a home server so that the management module 10 serves as an application on this server.

Available as a given number of program recorders capable of recording programs include a first recorder <1>110, a second recorder <2>120, a third recorder <3>130, a television receiver (hereinafter referred to as a television set) 140 provided with a recording function, a first personal computer (PC) <1>150, a second PC (which is not exclusively a PC and may be a portable mobile computer or a terminal device called a smartphone) <2>160, and an HDD 170 or a storage connected through the network, such as a LAN (local area network (LAN)-disk (HDD) or a network attached storage (NAS)-hard disk drive (HDD)). The HDD 170 is used as an external storage of, for example, the recorder <1>110, and is connected through a universal serial bus (USB). Moreover, Bluetooth (registered trademark) may be prepared so that a recorder device and an HDD device or a portable terminal device capable of passing data is connected therethrough.

Among the program recorders shown in FIG. 1, the recorder <1>110, the recorder <2>120, and the recorder <3>130 may have the same configuration (may be the same type). Although not described in detail, each of the program recorders includes at least a display controller for displaying a GUI as a video output on a display (or the television set) 140 connected thereto, a tuner capable of receiving a given broadcast, a video output for outputting images of a program to be reproduced to the connected display, a sound reproducer for reproducing sound of the program, a recording module for recording the images and sound of the program, an input that enables an instruction (to the recording module) to register and cancel or erase a recording reservation, and a reservation retaining module for storing the registration of the recording reservation.

On the other hand, among the program recorders shown in FIG. 1, the recorder <1>110, the recorder <2>120, and the recorder <3>130 may have different configurations (may be different types).

For example, the recorder <1>110 is capable of recording BS digital broadcasts, CS digital broadcasts, terrestrial digital broadcasts, and programs distributed via the network. The recorder <2>120 and the recorder <3>130 are only capable of recording the terrestrial digital broadcasts, and reproducing, mutually via the in-home network (or by DLNA connection), programs recorded by other recorders. The embodiment is described below on the assumption that the recorder <1>110 has a function substantially equal to the function of the television set 140 from which the display is removed, and that the recorder <2>120 and the recorder <3>130 have a function substantially equal to the function of the recorder <1>110 or the television set 140 except that the form of broadcasts received by their tuners is simpler (designed for terrestrial digital broadcasts only) than the recorder <1>110 and the television set 140. In addition, each device is preferably compatible with a DLNA-DMP (digital media player). Also, each device is preferably compatible with a DLNA-DMP (digital media player) or a DLNA-DMS (digital media server). Moreover, there is a difference of reproducible file formats or recording modes. For example, the recorder <1>110 and the recorder <2>120 support “MPEG-2” and “MPEG-4 (H-264AVC)” as reproducible moving image file formats, and the recorder <3>130 only supports “MPEG-2”.

The recorder <1>110, the recorder <2>120, and the recorder <3>130 may respectively support different media (recording media). For example, the recording module (image/sound recorder) in each recorder is only equipped with, for example, an HDD, or is capable of interacting with an optical disk or a memory card (SD card) to record and reproduce images and sound, or is capable of interacting with a recorder connectable via the USB or LAN to record and reproduce images and sound.

The television set 140 includes, for example, a tuner, a digital signal processor (DSP) responsible for various kinds of signal processing for reproducing a program tuned in to (selected) by the tuner, a recording module (image/sound recorder) for recording images and sound, a display for displaying images of the program tuned in to by the tuner, a sound reproducer for reproducing sound of the program tuned in to by the tuner, a video/audio output for supplying a recorder such as the recorder <1>110, the recorder <2>120, or the recorder <3>130 with the program tuned in to by the tuner device, namely, the images and sound as digital signals, a display controller for displaying a GUI (graphical user interface) on the display, a main controller (which may be referred to as a control block) responsible for, for example, signal control of the whole device and timing management of inter-component signals, and a network controller. The network controller preferably has at least a function of receiving control signals from a digital media controller (the DLNA-DMP) preferably compatible with the above-mentioned or the DLNA-DMS (digital media server).

The television set 140 includes, for example, an input section capable of indicating (inputting) registration or cancellation (erasing) of a recording reservation to the recording module, and a reservation retaining module for receiving and storing the recording reservation. The television set 140 may be provided with a combination of a monitor for video reproduction and a speaker for audio reproduction, or may provided with a monitor and a speaker in an independently-prepared form.

The tuner is capable of receiving, for example, terrestrial digital broadcasts, broadcasting satellite (BS) digital broadcasts (provided via a broadcast satellite), communication satellite (CS) digital broadcasts (provided via a communication satellite), and terrestrial analog broadcasts. The tuner may be provided integrally with the television set 140 or independently of the television set 140. As a program supply source, a server on the network (communication network) or a distribution station (regional network base station) is available. For example, a set-top box (STB) or a home server that functions as a tuner for tuning in to (selecting) a program provided via the network may be used together with the program supply source or prepared integrally with the program supply source.

When the terrestrial digital broadcasts are received, the signal processor includes, for example, a TS separator, a descrambler, a divider, and a decoder. The TS separator separates, from a received signal tuned in to by the tuner, a transport stream (TS) containing management information and a program. The management information includes, for example, information on the program supply source (broadcasting station), namely, a conditional access system (CAS) provider, and contract information prepared by the CAS provider. The descrambler descrambles an encryption key from the management information separated by the TS separator by use of identification information (CAS card) provided by the CAS provider. Thus, the descrambler obtains a video signal and an audio signal that constitute a program, namely, a packetized elementary stream (PES). The divider obtains the video signal and the audio signal from the PES. The decoder decodes the divided video signal and audio signal.

The CAS card retains the contract information for enabling limited reception of the digital broadcasts, and is referred to by the receivers (the television set 140, the recorder <1>110, the recorder <2>120, and the recorder <3>130, . . . ). In a general example of the distribution of programs via the network, a function corresponding to the CAS card is provided in software prepared in the receivers to enable the limited reception. In the digital broadcasting in Japan, the CAS card includes a CAS card compliant with ARIB STD-B25 managed by Association of Radio Industries and Businesses (ARIB), and CAS cards based on specifications independently established by broadcasters. Details of such CAS cards are not described.

The recording module (image/sound recorder) includes, for example, an HDD, and records images and sound, namely, programs in a predetermined recording format (mode) and at a predetermined rate. It goes without saying that an unshown encoder performs encoding during recording. The recording module (image/sound recorder) may be prepared in combination with, for example, a reader/writer and a disk drive. The image/sound recorder records images and sound in a semiconductor memory (memory card) called, for example, a secure digital (SD) card, and reproduces already recorded images and sound. The disk drive is capable of recording images and sound in, for example, an optical disk typified by a digital versatile disk (DVD) standard, and reproducing images and sound from the optical disk. It goes without saying that, for example, a digital visual interface (DVI) may be prepared as a video output.

The display is, for example, a liquid crystal display (LCD) panel, and has a predetermined resolution. It goes without saying that the display may be an externally connected monitor or a different television set.

The sound reproducer supplies an audio output to, for example, the speaker for reproducing a decoded audio signal and to an external output terminal. The audio output may be an optical digital output. That is, the optical digital output is advantageous to a combination of a monitor (including a projector device) and an audio visual (AV) amplifier.

The video/audio output includes a connector and a cable compliant with a high-definition digital media interface (HDMI). The video/audio output supplies, for example, the recorder <1>110 and the recorder <2>120 connected thereto via the HDMI cable with the decoded images and sound of the program in the form of digital signals under conditions optimum for the recorders to be able to reproduce the signals.

The main controller is responsible for signal control of the above-mentioned components (elements), namely, the whole television set, and also responsible for timing management of signals between the above-mentioned components (elements).

Except when, for example, the power plug is disconnected and it is physically difficult to receive electricity, a secondary power supply (e.g., a direct current (DC) of 31 V or 24 V or 5 V) supplied to the main controller except for the elements having a relatively high power consumption is generally ensured in, for example, the television set 140, the recorder <1>110, the recorder <2>120, or the recorder <3>130. Thus, for example, a storage incorporated in the television set or the recorder or connected to the television set or the recorder as an external storage can be activated at a prescribed time. Moreover, the television set or the recorder can always acquire “time information” called a time offset table (TOT) from the terrestrial digital broadcast received by a terrestrial digital tuner included in the tuner.

The management module 10 includes a communication module 11, an account manager 12, a group program reservation list managing module 13, a program data retaining module 14, a reservation coordinating module 15, a recorded program list retaining module 16, a recorded program list managing module (combined recorded program list creating module) 17, and others. In addition, the management module 10 is created by a reliable group such as a household or a group in a company (office). A right to access to a group is enabled by registering a member ID in this group created on the server (on the manager device). On the other hand, when each of the program recorders (the recorder <1>110 and the HDD 170, the recorder <2>120, the recorder <3>130, the television set 140, the PC (personal computer <1>) 150, and the PC <2> (mobile computer) 160) accesses the above-mentioned group by use of its member ID, its device management ID (media access control (MAC) address) is referred to and automatically registered.

The communication module 11 is responsible for passing content (programs) and control signals between the communication module 11 and the above-described connecting module 100. Also, the communication module 11 is capable of writing information into and reading information from a schedule management application compliant with a personal information manager (PIM) data standard disclosed on cloud computing (network/Internet), for example, an “iCalendar” prepared on an “iCalendar store server”. It should be noted that the “iCalendar” is nowadays often packaged in or supported by a mobile PC (corresponding to the PC <2>160 in FIG. 1), a personal digital assistant (PDA) or portable terminals and mobile telephones typified by a smartphone. For example, a schedule updated by a different user who uses a given terminal device which supports the application (in which the application is packaged) can be viewed. Moreover, the “iCalendar” is not dependent on a transmission protocol, so that the schedule can be shared on the above-mentioned network.

The communication module 11 is also capable of sending/receiving e-mail via the network, accessing an external server such as a program server (TV program store server) that retains electronic program guides (EPG) for terrestrial digital broadcasts, and acquiring EPG data from this server. Moreover, the connecting module 100 includes, for example, a local area network (LAN) controller, and reports, to the account manager 12 of the management module 10 through the communication module 11 of the management module 10, recording reservation status, recorded program information and a remaining recording capacity for the individual program recorders connected, and account information for the individual program recorders.

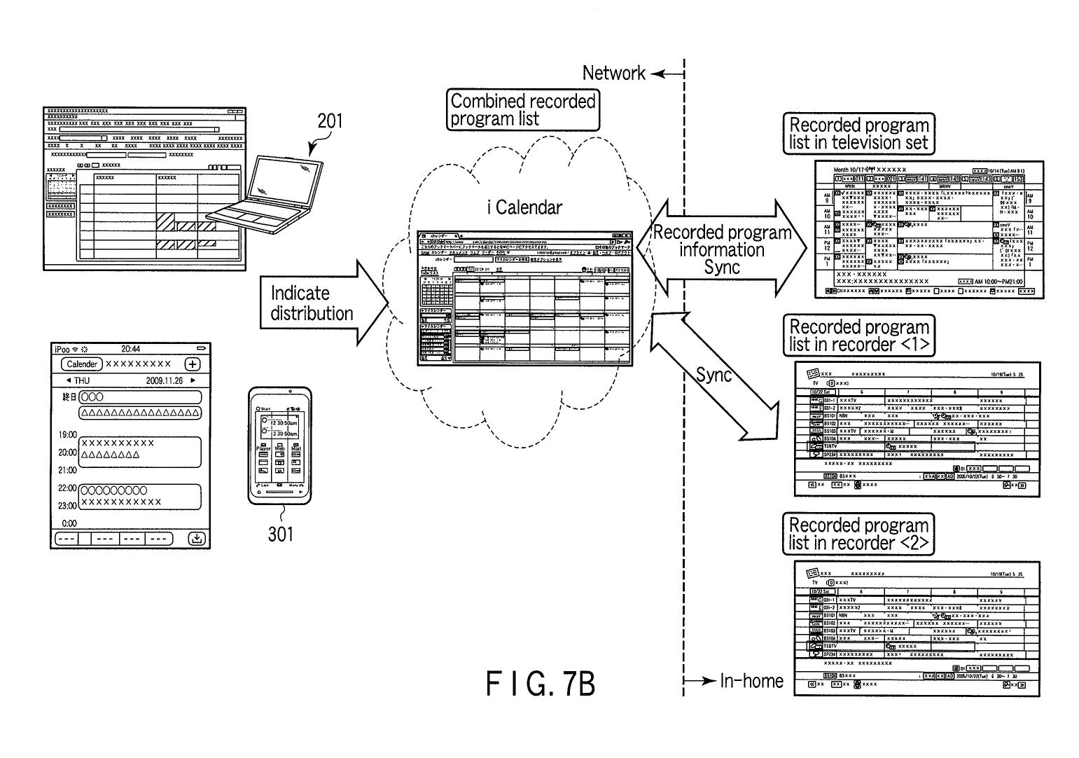

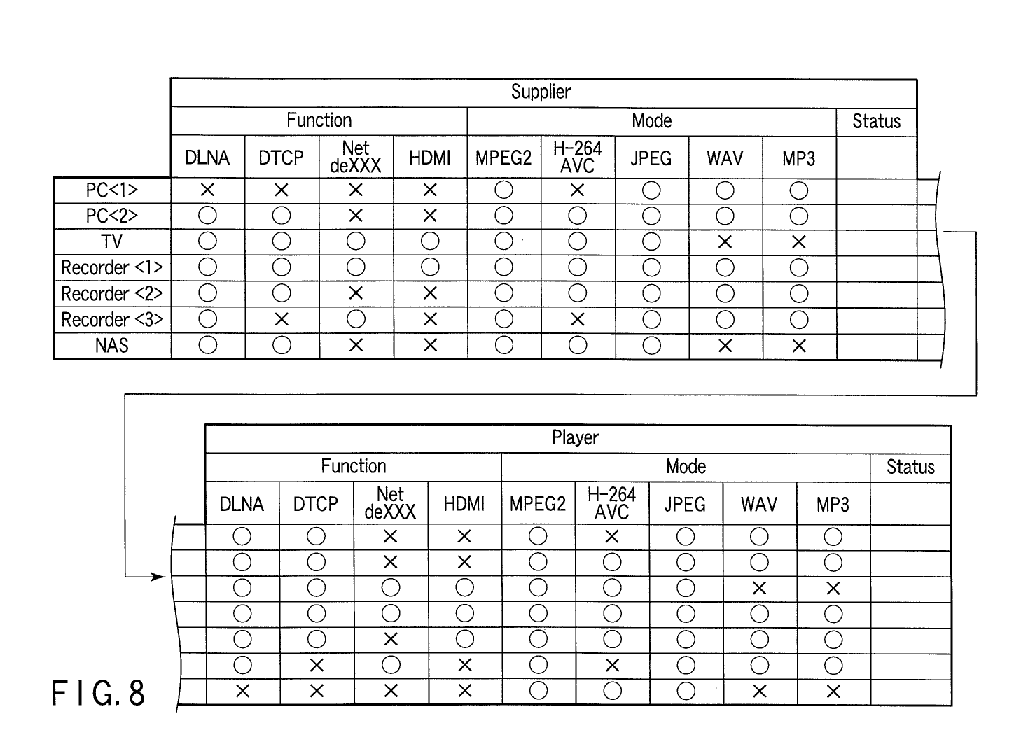

More specifically, the communication module 11 writes (updates), through the group program reservation list managing module 13, the recording reservation from the given program recorder managed by the management module 10, in the “iCalendar” the display example of which is shown in FIG. 6. In addition, the “iCalendar” is available if a given terminal device in which this application is packaged or which supports this application can be used to connect to the network (Internet/cloud computing). For example, as shown in FIG. 7, owing to a schedule display function prepared in each terminal device, information for programs reserved for recording in the given program recorder or information on whether a new recording reservation is permitted can be checked at any time without limitation, for example, whether the user is out of the house, in an office or on the way home. If necessary, a new recording reservation can be set (added) at any time.

The account manager 12 includes an account managing module 12-1 for acquiring the account information for the user who owns the above-mentioned program recorder or for the program recorders owned by the user and managing accounts, a device information managing module 12-2 for acquiring a recordable condition of each of the program recorders and setting a device available for recording, and a reservation list managing module 12-3 for retaining a recording reservation list and recorded program list for each of the program recorders.

The above-mentioned recording reservation list and/or list information comprising the recorded program list is retained as a list for each program recorder registered in the above-mentioned group in the reservation list managing module 12-3. Using the device information retained by the device information managing module 12-2, the reservation list managing module 12-3 filters or merges the lists for the above-mentioned recorders to generate a group program reservation list or a group recorded list.

Information managed by the account managing module 12-1 is, for example,

A> the presence of an account for a program that is viewed for free or a program that is viewed for free but requires subscription (including a program provider requiring subscription), for example,

when the given program recorder makes a recording reservation (recording request) for a program provided by a particular program provider, a contract with this program provider, that is, the presence of an account is checked, and whether the recording reservation can be made is determined. Information managed by the device information managing module 12-2 is, for example,

1> the presence of a subscription to receive BS broadcasting or CS broadcasting (the presence of a CAS card and the presence of a subscription), and the conditions of antenna connection,

2> the presence of a subscription made with a program distributor provided to enable programs desired by the user via the network to be acquired, the presence of a contract for connection to the network, and the speed of a circuit,

3> the presence of a CAS card that enables the reception of terrestrial digital broadcasts (the presence of a reception registration for a broadcaster of terrestrial digital broadcasts),

4> a recording capacity for recording programs, that is, a free space of the HDD,

5> conditions of already reserved recording, that is, the time scheduled for a recording reservation and the presence of recording reservations before and after this time,

6> the time in which a recording reservation can be accepted (the number of minutes available for a recording reservation before the start of a program to be reserved), and

7> the time for accepting a recording reservation by e-mail and the start time of the program to be reserved for recording (whether a recording device in question accepts the recording reservation when the recording reservation is sent). For example, when there is a recording reservation (recording request) for a program provided by a particular program provider from the given program recorder, whether the program recorder which has made the recording request can record the program is checked. It should be noted that the CAS card includes, for example, a B-CAS card that enables the reception of BS broadcasts and terrestrial digital broadcasts, and a C-CAS card that only enables the reception of terrestrial digital broadcasts. The programs that can be recorded by the individual program recorders and broadcasters are recognized together with the account information managed by the account managing module 12-1.

The reservation list managing module 12-3 retains the status of the recording reservation in each of the program recorders as the reservation list so that the device information managing module 12-2 can refer to the reservation list. As shown, the reservation list is prepared for each of the program recorders.

The group program reservation list managing module 13 collectively retains, as a consolidated reservation table (list), the programs which are retained by the reservation list managing module 12-3 of the account manager 12 and which are reserved for recording by the respective program recorders. The group program reservation list managing module 13 also updates, through the communication module 11, the recording reservations for each of the program recorders retained by the above-mentioned “iCalendar”. Although described later, the consolidated reservation table retained by the group program reservation list managing module 13 can be displayed in the given program recorder simultaneously with the recording reservations made in the other program recorders managed by the management module 10 when the recording reservation list in this program recorder is displayed.

The program data retaining module 14 provides program data for a given program recordable by each of the program recorders the recording reservation status of which is managed by the account managing module 12-1 and the device information managing module 12-2 of the account manager 12 so that the program recorder which has made the recording request can acquire the program data. The program data may be electronic program guides (EPG) supplied by the above-mentioned TV program server, a copy of, for example, program lists (content table) which are supplied by a server independently prepared by a manufacturer that provides the above-mentioned program recorder or which are supplied by a program provider providing programs that are viewed for free but require subscription, or a list (consolidated program list) that is a combination of the EPGs and the program lists.

When the group program reservation list or the recorded list is needed, that is, when a recording reservation is newly registered (a recording reservation is set) or recording reservations are checked for duplication, each of the program recorders sends a request to the management module 10.

In response to the request, the management module 10 filters a database in the reservation list managing module 12-3, creates a list corresponding to the request, and sends back the list to the program recorder which has sent the request.

Each of the program recorders receives this list, and checks whether the program is already reserved for recording. When duplication of recording reservations can be found as a result of the check, each of the program recorders indicates the duplication of recording reservations by use of the GUI (graphical user interface) or an icon. When the recording reservations are duplicated, means or a function for sending a “recording deletion request” that uses a local network is used to delete the recording reservation for one of the program recorders if both of the program recorders support this means or function. After completion of the deletion, a correction by the main operation is uploaded to the server, namely, the management module 10. When there is locally no request sending means, a request is sent to the management module 10, and the other device which has received the request performs the deletion. Although not shown, an icon, for example, that indicates that a request is being made is displayed on the GUI during a wait for the completion of the deletion.

When there is a new recording reservation (recording request) from one of or two or more of the given number of program recorders connected to the management module 10 through the connecting module 100, that is, the television set 140, the recorder <1>110, the HDD 170, the recorder <2>120, and the recorder <3>130, the PC <1>150, and the PC <2>160, the reservation coordinating module 15 performs reservation coordination by, for example, judging whether there is any “recording reservation for the same program” in the other program recorders and recommending recording by a program recorder different from the program recorder which has requested the recording reservation.

For example, if the program recorder which has requested the recording reservation has a recording reservation for a preceding program that may be extended in its broadcasting time, a recording reservation by another program recorder which does not have any recording reservations before and after the relevant time slot is recommended. Thus, for example, even when the broadcasting time of the preceding program that may be extended in its broadcasting time is actually extended, the recording reservation for the requested program is prevented from being influenced thereby. Moreover, for example, when the remaining recording capacity of the program recorder to which a request for the recording reservation is made is small, the recording reservation is made by another program recorder having enough remaining recording capacity. Thus, in the program recorder to which a request for the recording reservation is made, there is a reduced amount of additional necessary operations including, for example, moving several recorded programs (to another program recorder) for the next recording reservation.

On the other hand, when the program recorder which has requested the recording reservation already has a recording reservation that overlaps in time, whether there is any other program recorder available for the requested new recording reservation is judged. The presence of the other program recorder available for the recording reservation can be reported to the program recorder which has requested the recording reservation.

Furthermore, the reservation coordinating module 15 is particularly advantageous when a request for a new recording reservation is externally made to the management module 10, for example, by e-mail. For example, when the (specified) program recorder which has specified a particular program recorder and to which a request for the recording reservation is made already has a recording reservation, another program recorder available for recording reservations can be used for the recording reservation. Although described in detail later, the fact that a new reservation destination, namely, another program recorder available for recording reservations can be used for the recording reservation is reported to the user (a source of an external reservation request) by return e-mail when the recording reservation by another program recorder available for recording reservations is accepted as well as when the specified program recorder can be used for the recording reservation.

Although described in detail later, it goes without saying that the reservation coordinating module 15 refers to the account manager 12 (the account managing module 12-1, the device information managing module 12-2, and the reservation list managing module 12-3) of the management module 10 and the group program reservation list managing module 13, and then specifies a program recorder that can fulfill the request for the new recording reservation, on the basis of the program information retained by the program data retaining module 14.

That is, the reservation coordinating module 15 is used to find any duplication of recording reservations and adjust and eliminate the duplication problem in the above-described manner. When any one of the program recorders on the in-home network is in charge of the reservation coordinating module 15, this program recorder is operable when sleeping (powered off) or disconnected from the network. Therefore, before this program recorder is disconnected from the network, the above-mentioned coordination processing has to be passed to another program recorder. For example, whether there is any program recorder having a reservation coordinating function in the in-home network is checked by broadcasting. When the presence of a program recorder having the reservation coordinating function can be recognized, the current “status” information, for example, is passed to this program recorder.

When it is found out that the coordination of the recording reservations is complex, for example, when a recording reservation that partly overlaps in time is already registered in another program recorder, the reservation coordinating module 15 sends, through the communication module 11, e-mail “to require coordination” to the PC <1>150 or the PC (mobile computer <2>) 160 connected to the management module 10. Thus, the reservation coordinating module 15 requests the user to specify a program recorder to make the recording reservation for a program that is high in the order of priority for recording.

The reservation coordinating module 15 also updates the above-mentioned “iCalendar” through the communication module 11 to check whether there is any recording reservation in the program recorder before the time of receiving e-mail, in connection with the program recorder which can be estimated to be available for recording reservations but in which the actually set recording reservations cannot be checked, for example, the program recorder which is not powered on or the program recorder which is available for a recording reservation by e-mail.

As a result, at the point where, for example, the program recorder which is not powered on is activated in accordance with (another) recording reservation set in this program recorder, whether there is any recording reservation that specifies this program recorder (whether the registered recording reservation can be made) can be judged on the “iCalendar”.

Moreover, at the point where the program recorder available for recording reservations by e-mail has reached the time of receiving e-mail, whether there is any recording reservation which is retained by the “iCalendar” and which specifies this program recorder (whether the registered recording reservation can be made) can be judged.

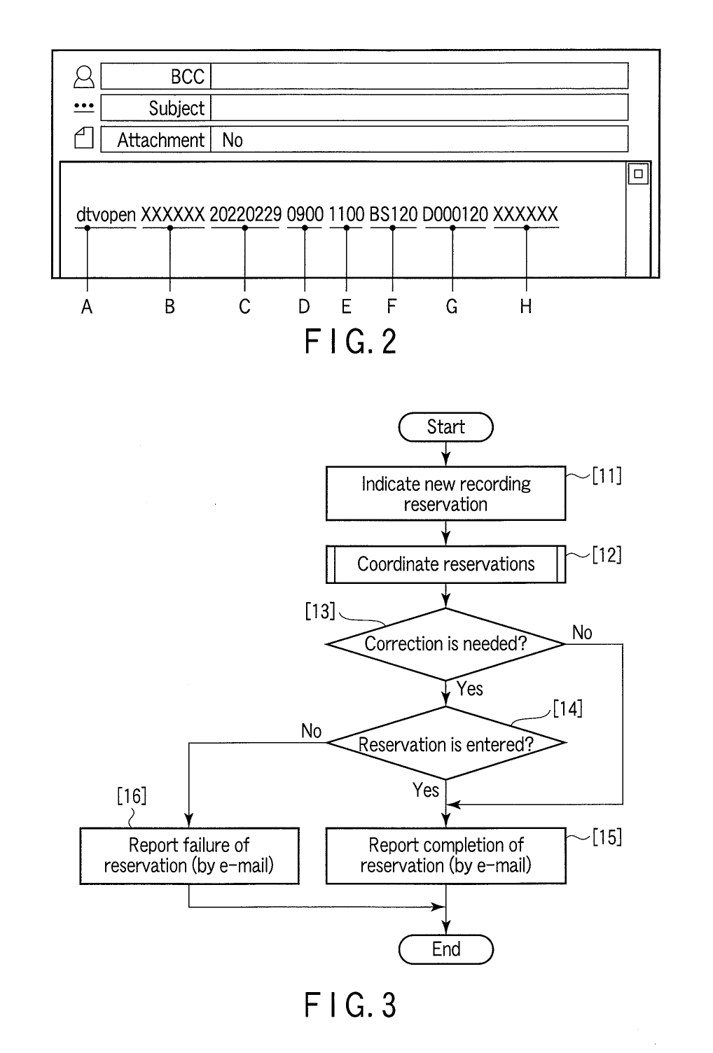

The recording reservation for a program by e-mail can be registered by sending the following using a mail form shown by way of example in FIG. 2,

A> identification code “dtvopen”

B> password “@abx3=password”

C> recording date “20220229”: Feb. 29, 2022

D> recording start time “acaa=hour on a 24-hour basis and minute”

E> recording end time “cabd=hour on a 24-hour basis and minute”

F> recording channel “xxx=three digits after a broadcast type”

G> recording destination “yyyNNMM=registered characters and numbers” and

H> recording mode (rate) “zz.z=specified character string”.

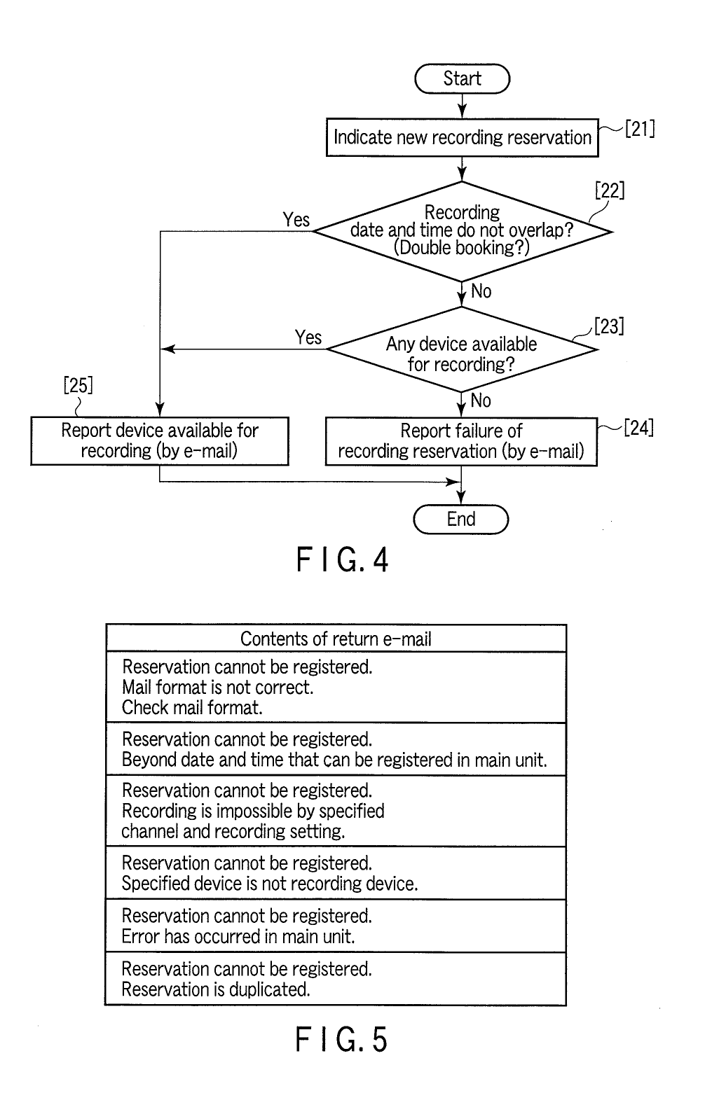

FIG. 3 shows, in a software-like manner, how to judge whether new recording reservations (recording requests) should be coordinated with already registered recording reservations when the new recording reservations are created from the given number of program recorders connected to the management module 10, that is, the television set 140, the recorder <1>110, the recorder <2>120, and the recorder <3>130, the PC <1>150, and the PC <2>160.

For example, when a new tentative reservation (new recording reservation) is indicated by e-mail in the mail form shown by way of example in FIG. 2 [11], reservation coordination is performed [12].

In the reservation coordination, when the new tentative recording reservation indicated by e-mail should be changed (modified) [13-YES] and when the recording reservation can be made by changing (modifying) the new tentative reservation [14-YES], a “recording reservation (proposal)” for such a change is sent back to the user by e-mail. The “recording reservation (proposal)” says, for example, “Program recorder is changed and recording reservation has been made. Recording reservation has been made in recorder <2> (RD-000×)” [15].

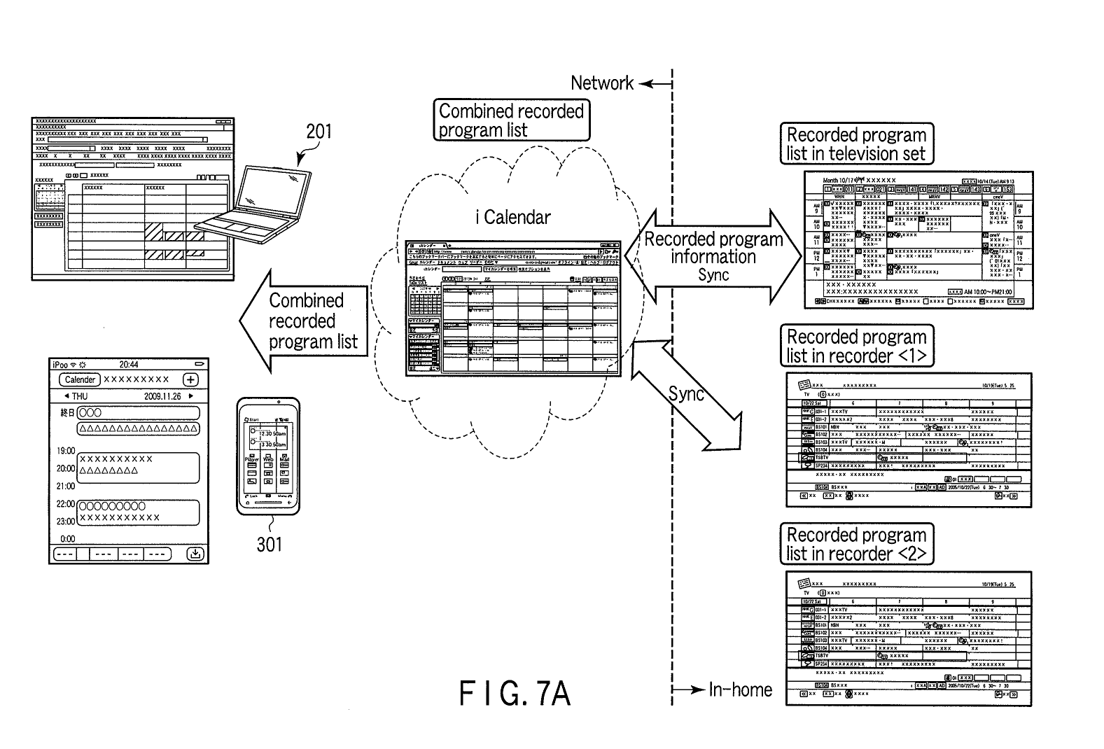

When the new tentative reservation indicated by e-mail should be changed (modified) [13-YES] and when the recording reservation cannot be made even by changing (modifying) the new tentative reservation (the change of the recording reservation has failed) [14-NO], an e-mail message reporting that the recording reservation cannot be made (the change of the recording reservation has failed), for example, “Reservation cannot be registered. Reservation is duplicated.” as shown by way of example in FIG. 5 is sent back to the user [16].

When there is no need to change (modify) the new tentative reservation indicated by e-mail [13-NO], a message indicating the completion of the recording reservation is sent back by e-mail [17].

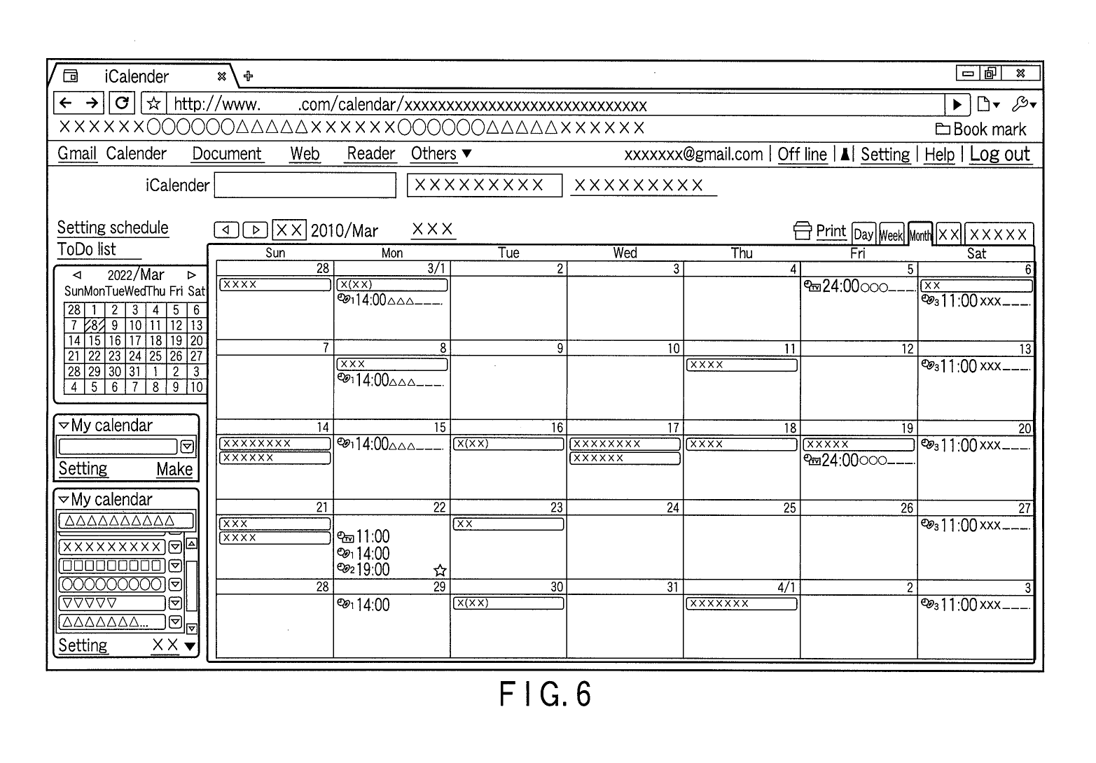

FIG. 4 shows, in a software-like manner, a more detailed procedure of the reservation coordination shown in FIG. 3.

When the new tentative reservation (new recording reservation) is indicated by e-mail [21], whether there is no overlapping (double booking) of recording date and time are checked [22].

When there is overlapping of recording date and time [22-NO], whether there is any program recorder that can record the program targeted for the new recording reservation (indicated by e-mail) is checked by reference to the information (device information) retained by the device information managing module 12-2 and the account managing module 12-1[23].

When there is no program recorder that can record the program targeted for the new recording reservation (indicated by e-mail) [23-NO], an e-mail message reporting that the recording reservation cannot be made (the reservation coordination has failed), for example, “Reservation cannot be registered. Reservation is duplicated.” as shown by way of example in FIG. 5 is sent back to the user by e-mail [24].

When there is a program recorder that can record the program targeted for the new recording reservation (indicated by e-mail) [23-YES], an e-mail message reporting that the recording reservation is finished, for example, “Program recorder is changed and recording reservation has been made. Recording reservation has been made in television set OOZΔΔΔ” is sent back [25].

The coordination by the reservation coordinating module 15 conforms to the above-mentioned information A> and 1> to 7> retained by the account managing module 12-1 and the device information managing module 12-2. For example, the following is checked to change the program recorder,

a) Is there any previous reservation?

b) The time before the start time of recording (how many minutes are there before the reservation can be set?) and

c) When is a reservation server checked next if the device is off (That is, there is, for example, a schedule for the target device to take the reservation list)?.

Even, the program recording device (designated by e-mail) is available for recording, the recording reservation can be transferred (the recording reservation can be set in a program recording device different from the designated program recording device) on the basis of, for example, the remaining recording capacity of the HDD.

The recorded program list retaining module 16 retains, for each of the program recorders as an individual list in a form that can be referred to by the recorded program list managing module (combined recorded program list creating module) 17, the name of the program which has been “recorded” in accordance with the recording reservation, recording start time and date as well as recording end time and date, or recording start time and date as well as recording time (program length), a channel or program supply source, a format and a recording mode, in connection with the respective program recorders retained by the reservation list managing module 12-3, that is, the recorder <1>110, the recorder <2>120, and the recorder <3>130, the television set 140, . . . , and the HDD 170 shown in FIG. 1. Attachable to the individual list as information specific to each of the recorded programs is, for example, information regarding the authentication and viewable age limit for DTCP-IP (Internet protocol) in which digital transmission content protection (DTPC)/DTCP is applied to DLNA, and the environment (factor) to which reproduction may be limited when a recorded program is reproduced, for example, the permission and restriction on the number of dubbings (copying). Also added as specific information for each recorded program are information on the device in which the program is recorded, such as the name of the manufacturer, and the product number (ID) of the recorder (internal HDD).

The recorded program list managing module 17 combines the (individual) lists of the programs recorded by the respective program recorders and retained by the recorded program list retaining module 16, and creates a “combined recorded program list” that can be referred to in the form of the “iCalendar”. The combined recorded program list is updated under the control of the management module 10 and the communication module 11 whenever recorded programs increase in a given program recorder (the “recording” is finished in accordance with the recording reservation in each of the program recorders). The combined recorded program list indicated by the “iCalendar” is also updated whenever recorded programs increase in the given program recorder (the “recording” is finished in accordance with the recording reservation in each of the program recorders).

Even, if the respective recorded programs include the same program, the format/mode/rate ID of the device used for recording are also listed (listed in the combined recorded program list).

An example of the “combined recorded program list” (in the form of the “iCalendar”) created by the recorded program list managing module 17 is shown in FIG. 6. This example is shown by using a general browser. It is apparent that “OOO . . . ” starting at 14:00 is already recorded in the recorder <1>110 (see FIG. 1) every Monday, and that “ΔΔ˜˜˜” starting at 11:00 is already recorded in the television set 140 on the 22nd (Monday).

It is also apparent that “□□..□□˜” at 19:00 is already recorded in the recorder <2>120 on the 22nd.

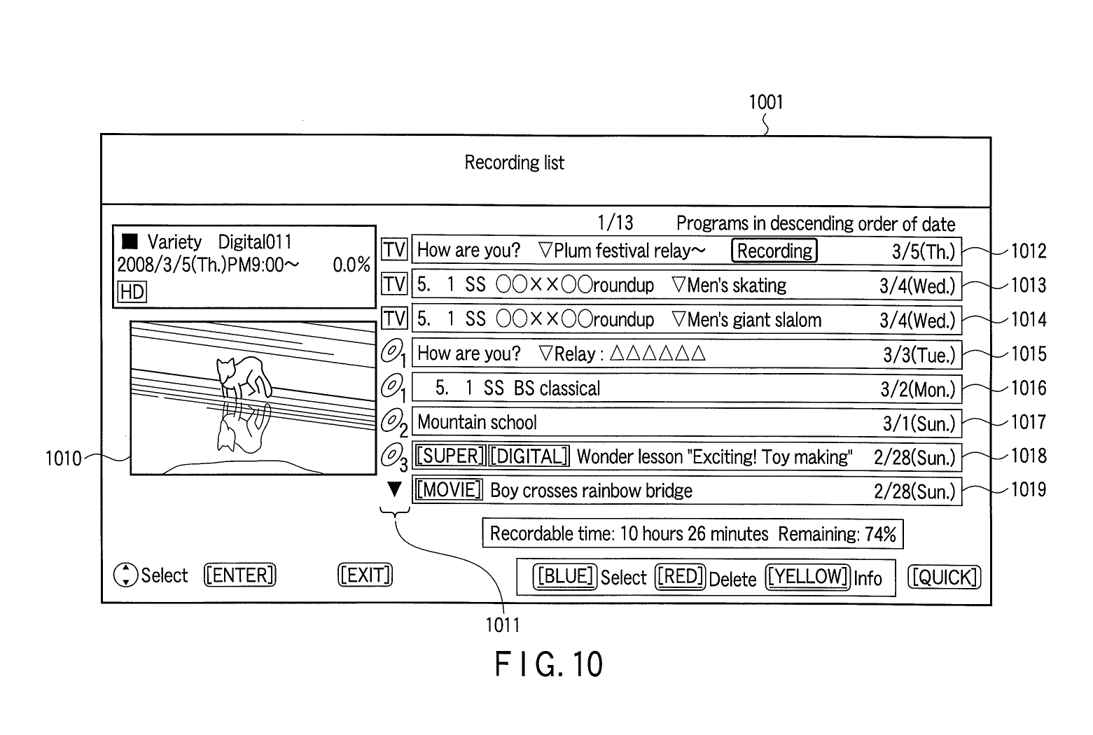

This list can be viewed at any time by any terminal device supporting the “iCalendar” shown in FIG. 6, such as a personal computer (PC) 201 (see FIG. 1) or a smartphone (X01T (brand name)) 301 (see FIG. 1), as shown in FIG. 7A. An example of the “combined recorded program list” is shown in FIG. 10. When no viewer is prepared in the smartphone 301, the user can be guided to the Website (homepage) provided by the manufacturer or supplier of the smartphone (e.g., a “link” is prepared) so that a player application for the smartphone can be downloaded (acquired).

In this case, a reproducer (local) can read the recorded program list and display the list in the screen of its display. When the reproducer (local) does not have the program, whether the program is adapted to the protocol described in the recorded program list is checked. Only when the program is adapted to the protocol can the name of the program be indicated on the list. That is, when the local reproducer) does not have the listed program, the reproducer refers to the protocol and address information if the user instructs the reproducer to reproduce the program in the list. In the case of a local (reproducer), a corresponding device (media player) is instructed to reproduce the program. In the case of a network, the server on the network is instructed to perform a data download including streaming in accordance with a predetermined procedure. Thus, a recorded program recorded by any device can be reproduced.

Meanwhile, in recording a given program, the recording device used for the recording of the program is permitted to record this program. For example, a program, for example, a BS digital broadcast, can be recorded after being authenticated with the CAS card. Therefore, each of the recorded programs has cleared various permissions and recording enabling requirements that are imposed at the time of recording.

On the other hand, when a particular recording device in the network (DLNA) is used to reproduce a recorded program recorded by a given (another) recording device, not all of the programs included in the “combined recorded program list” can be reproduced in all of the (given) recording devices. For example, a program is not adapted to (does not support) the format of a target recorded program, or a reproduction permission is needed due to a viewing age limit, and a reproduction request is therefore made by a particular recording device (local). In this case, it is preferable that the programs permitted to be reproduced by this recording device (local) be only presented as the “combined recorded program list”.

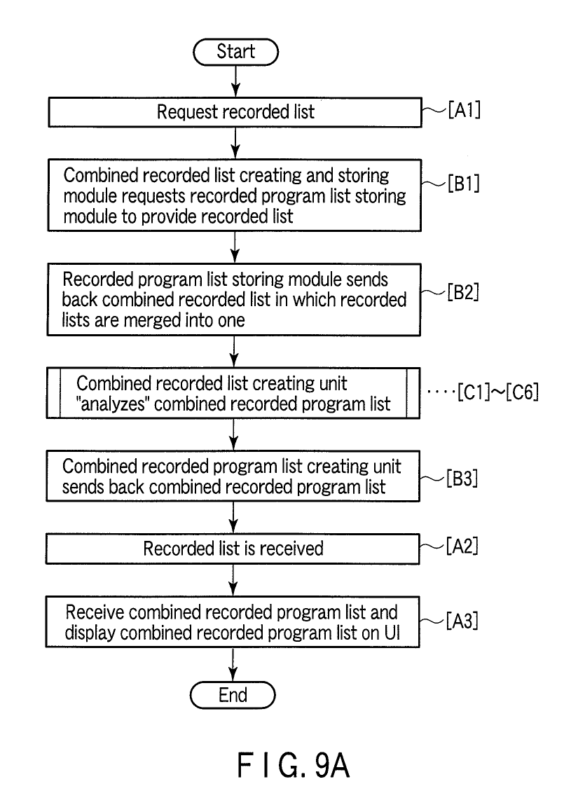

Under these circumstances, it is preferable that the programs be filtered by a “device information list” shown in FIG. 8 that indicates functions and corresponding formats permitted to each of the recording devices in the network (DLNA) so that the programs that can be reproduced by the recording device (local) to reproduce (view) the recorded program may be only presented.

In FIG. 8, “distribution device” indicates a function or a corresponding format applied to the recorded program when a given recording device is used for program recording, and “reproducing device” indicates a function or a corresponding format applied when a given recording device is used to reproduce (view) the recorded program.

In addition, the “reproducing device” includes functions and conditions applied when the recording device (local) is in operation. For example, one of the conditions is that during a normal state (during deactivation), a recorded program [X] cannot be reproduced even by the recording device (local) capable of reproducing the recorded program [X] in which, for example, a broadcast in a “TS” format is recorded in a standard recording mode (rate) while this device is in operation for dubbing that requires a mode (rate) transformation. Therefore, it is preferable that “status” indicating the presence of a function restriction dependent on operation state or exclusion conditions be added to the section “reproducing device” in the “device information list”. “Status” is preferably indicated by, for example, an icon or pictogram for a factor or a condition that tends to be relatively highly frequently displayed. It goes without saying that “status” can also be directly displayed by a character string. For the character string, more messages can be displayed by using a technique such as a ticker (a character string is displayed within a fixed display region in a flowing (scrolling) manner).

“Reproducing device” also includes functions and conditions applied in association with operations scheduled in the local device scheduled to reproduce. For example, one of the conditions is that there is a recording reservation that should be started before the end time of a program scheduled to be reproduced in the local device. Therefore, it is preferable that the reproduction enabled time or “status” indicating that reproduction is stopped by the execution of the recording reservation be added to the desired section “reproducing device” in the “device information list”.

“Reproducing device” can also display information on a program that has been reproduced partway by the local device or a given device. For example, “N (N indicates a reproduction time, and is one or a combination of hour/minute/second)” alone or, depending on the number of chapters, Y/Z (Y is the number of reproduced chapters, and Z is the total number of chapters) can be displayed in a device different from the local device.

Furthermore, “status”, “mode” or “format” may include one or a combination of the following examples, some of which overlap the examples in FIG. 8,
As distribution functions <transmission>
   DLNA
   DLNA-DMC (digital media controller)
   DLNA-DMP (digital media player)
   DLNA-DMS (digital media server)
   DTCP-IP (Internet protocol)
   Net de dubbing <enabled by RO-E10□□K (product name)>
   HDMI.

Furthermore, “status”, “mode” or “format” may include one or a combination of the following examples, some of which overlap the examples in FIG. 8,
As recording modes <transmission>
   Moving image <MPEG-1/-2/
   4(AVC)/TS (pass-through)/video format/VR format/resolution/copy-once/dubbing 10>
   Still image <JPEG (joint photographic experts group)>
   Music <WAV (wave form audio format)/MP3 (MPEG audio layer-3)/PCM (pulse coded module)>
   Distribution restrictions (area/age).

Furthermore, “status”, “mode” or “format” may include one or a combination of the following examples, some of which overlap the examples in FIG. 8,
As reproducing functions <reception>
   DLNA
   DLNA-DMC
   DLNA-DMR
   DLNA-DMS
   DTCP-IP
   Net de dubbing <enabled by RO-E10□□K (product name)>
   HDMI
   Power off
   WOL (wake on LAN).

Furthermore, “status”, “mode” or “format” may include one or a combination of the following examples, some of which overlap the examples in FIG. 8,
Recording modes <reception>
   Moving image <MPEG-1/-2/-4(H-264AVC)/TS (pass-through)/(presence of) finalization/finalization [in action]>
   Still image <JPEG>
   Music <WAV/MP3>.

Regarding the presence of information for functional restrictions (distribution restrictions) in distribution, the following needs to be taken into consideration as factors to be uploaded to the server:

For example, DMS distribution is not enabled during recording,

When “a distribution may be stopped in the middle of program reproduction, and (therefore) a recorded list is requested”,

A) whether there is any restriction in distribution is checked,

A-1) a flag indicating whether distribution is restricted is checked,

A-2) the reservation list is checked when the distribution restriction is a recording mode,

whether a corresponding reservation is made within a content reproduction time is checked, and

in the case corresponding to A-1) or A-2),

B-1) some other device capable of reproduction without restrictions is found,

B-2) the fact that reproduction is stopped in N minutes is reported (to the user).

Moreover, the following needs to be taken into consideration for the functional restrictions:

The internal state of the device is uploaded to the server,
(or) the server periodically makes inquiries <state> power on (O)/power off (x)

[0]: no distribution restriction

[1]: NG <impossible> during TS recording

[2]: NG <impossible> during maintenance.

It is more convenient for a reproducer which discloses, in a device on the network, the programs retained in the local reproducer if:

1) its flag is set in the device information for a synchronization system before reproduction from the network is acceptable,

2) in order to turn the device into a sleep mode or off by, for example, user operation, its flag is set in the device information for the synchronization system, and information (e.g., a MAC address) is set together for WOL as needed.

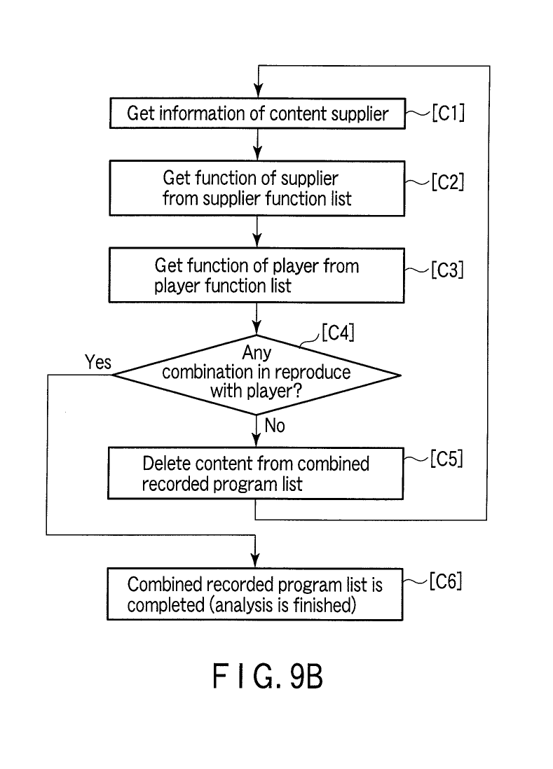

In the above-mentioned filtering to create the “combined recorded program list” that lists the recorded programs reproducible by the local reproducer, when there is a request for the transmission of the recorded program list from the local device (e.g., the television set 140) as shown by way of example in FIG. 9A and FIG. 9B, a connection is established with the recorded program list managing module 17 via the connecting module 100 and the communication module 11 of the management module 10, and then reading of the (individual) list, which is retained by the recorded program list retaining module 16, for the programs recorded by each of the program recorders is requested [A1].

In response to the request to read the individual list, the (individual) list, which is retained by the recorded program list retaining module 16, for the programs recorded by each of the program recorders is read [B1], and the “combined recorded program list” that can be referred to in the form of the “iCalendar” is created [B2].

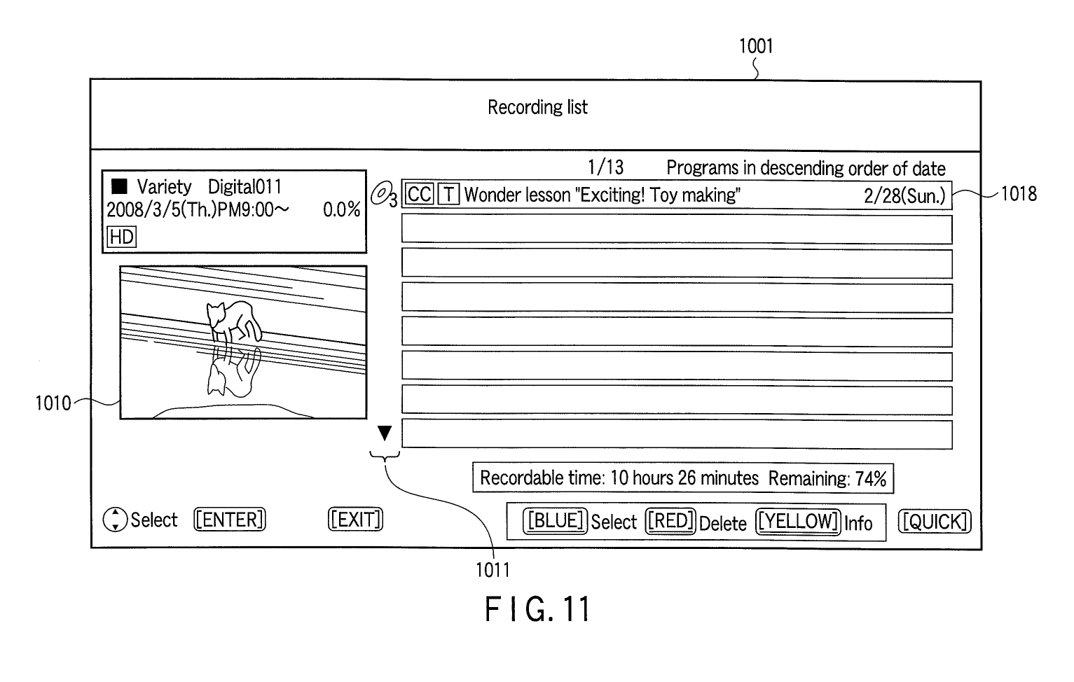

In the created “combined recorded program list”, functions and conditions for the distribution device capable of providing (distributing) the recorded programs that can be viewed by the local device by reference to the a “recorded program supply source (distribution device)” list shown by way of example in FIG. 8 [C1] are listed as an analysis process shown in FIG. 9B [C2]. At the same time or in accordance with a predetermined timing, information (functions and conditions for the distribution device) on the reproducible recorded programs is acquired for the device (local) which has been requested to reproduce the program [C3], and this information is compared with the list of the functions and conditions for the distribution device [C4], and then the programs that cannot be reproduced by the local device are removed from the “combined recorded program list” [C5]. Thus, the “combined recorded program list” in which the recorded programs that can be reproduced by the local device which has been requested to reproduce the program are only listed (filtered) is obtained [C6]. An example of the filtered “combined recorded program list” (for a particular reproducing device) is shown in FIG. 11.

The filtered “combined recorded program list” thus obtained is updated to be viewable as an “iCalendar” on a cloud, as shown in FIG. 7B [B3].

The ‘filtered “combined recorded program list”’ is supplied to the device which has been requested to reproduce the program in such a manner as to be displayable on a user interface (UI) [A2].

Furthermore, the “filtering” described with reference to FIG. 9A and FIG. 9B can be explained in a software-like manner, for example, as follows:
<Reproducing device (x)> requests recorded lists
Cloud server
   The combined recorded list creating module 17 to request “recorded lists” from a recorded list storage module 16,
   The recorded list storage module 16 merges the “recorded lists” into one list to create a “combined recorded list”,
   The recorded list storage module 16 sends back the “combined recorded list”
   The combined recorded list creating module 17 analyses the “combined recorded list”,
[Analysis]
   A device to distribute the program is taken out (extracted/searched for),
   A distribution function of the distribution device is taken out (searched for/extracted) from a distribution function list,
   A reproducing function of the reproducing device is taken out (searched for) from the distribution (function) list,
   Whether there is a combination that enables the reproducing device to receive content is checked (searched for),
   <Y> A distribution device is taken out (extracted [O]/receivable),
   <N> The content is deleted (unreceivable/extracted [x]) from a combined recorded list,
Cloud server
   The combined recorded list creating module 17→requests the “combined recorded list”
A <reproducing device (x)> receives recorded list.

So far, the ‘filtered “combined recorded program list”’ is retained by the local device for UI display, and displayed in accordance with display conditions or a display method of the local device [A3].

Thus, the viewer (user who has requested the recorded program list from the local device) can reproduce the currently reproducible (viewable) recorded programs in the local device without any stop in the middle of reproduction or without any cancellation of the recording reservation scheduled in the local device or without any reservation change to some other device available for recording. Since the ‘filtered “combined recorded program list”’ contains the “status” shown in FIG. 8, limited reproduction of the program, for example, before the start of the recording reservation set in the local device can be selected.

When the local is compliant with DLNA-DMP, the “iCalendar” allows the operation schedule (recording reservation) of the local device to be changed in accordance with the “status” attached to the “combined recorded program list” from the smartphone 301 or the PC 201 (including the case where the PC <2>160 is carried in the example of FIG. 1) which is a browsing device compliant with DLNA-DMC so that there will be no influence on the viewing of the recorded program to be viewed. Moreover, when the browsing device (e.g., the smartphone or the PC <2>) used to browse the “iCalendar” is the local device (reproducing device) (the “iCalendar” is browsed by the local device), a recorded program adapted to the format installed in the local device can be reproduced (viewed) on the spot. However, for copy-once programs (which can only be moved), a message urging the user to reproduce (view) with the device used for recording may be indicated to eliminate the possibility that the program cannot be viewed (reproduced) inadvertently.

A display example of the “combined recorded program list (recording list)” is shown in FIG. 10, and a display example of the ‘filtered “combined recorded program list (recording list)”’ for the recorder <3>130 is shown in FIG. 11. Each of the display examples is substantially an example of a screen displayed on the display in the case of the television set 140, but, in the case of the recorder <3>130, is an example of a screen that is displayed on the monitor (or the television set 140) connected to the recorder <3>130.

FIG. 10 shows the display example of the “combined recorded program list (recording list)”. In this example, a reproduced image of the program currently being recorded with an indication 1012 (highlighted) on which a cursor is placed is displayed in a selected program display region 1010 within a screen display 1001. In addition, signs or icon-like identification marks indicating the program recorders which have recorded the record (recorded) program indicated by the indications 1021 to 1019 are indicated in a program recorder indicating section 1011 at predetermined positions (in this example, in the vicinity of the heads on the left) of the indications 1012 to 1019. Thus, the program recorders in which the respective programs are recorded can be identified.

For example, it is obvious that the programs of the indications 1012 to 1014 are recorded in the television set (140 in FIG. 1), the programs of the indications 1015 and to 1016 are recorded in the recorder <1> (110 in FIG. 1), the program of the indication 1017 is recorded in the recorder <2> (120 in FIG. 1), and the program of the indication 1018 is recorded in the recorder <3> (130 in FIG. 1).

This shows that the program which can be reproduced by the recorder <3> with no need for re-encoding, namely, mode conversion is the program of the indication 1018 and that, for example, the indications 1015 and 1016 cannot be reproduced (not targeted for reception) by the recorder <3> at this stage.

It is found out from FIG. 10 and FIG. 11 that in the ‘filtered “combined recorded program list”’, the program indicated by the indication 1018 is only extracted from the “combined recorded program list” shown in FIG. 10 so that the recorder <3>130 can reproduce this program.

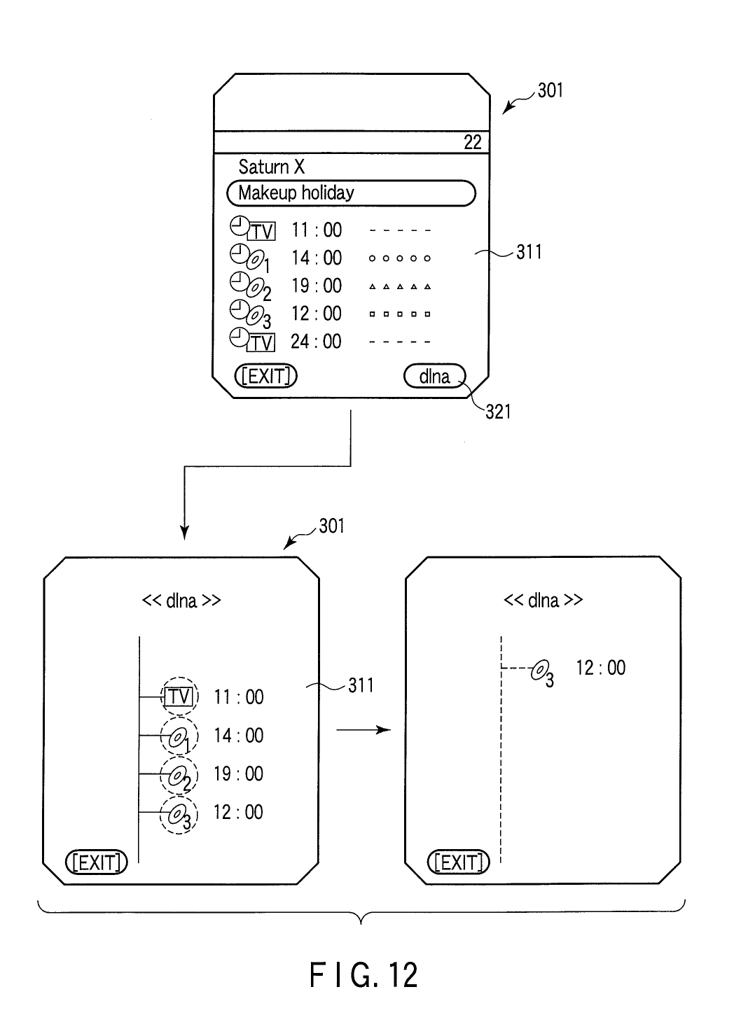

In the example shown in FIG. 12, a smartphone (portable terminal device) is used to instruct a given reproducer to reproduce a recorded program out of the “combined recorded program list” shown in FIG. 6 (a condition in which the “combined recorded program list” can be referred to by the smartphone as shown in FIG. 7A) in accordance with the ‘filtered “combined recorded program list”’ so that “status”, “mode”, “format”, and “distribution restriction” described with reference to FIG. 8 are taken into consideration.

In the example shown in FIG. 7A, if the user touches the indication of a particular program or date or if the user selects a particular program or date by, for example, an icon, a range for one day or for predetermined hours, or the name of a particular program is displayed in a predetermined size (e.g., displayed in a magnified form) in the display region of the smartphone 301 in accordance with the example of FIG. 12. In addition, an indication such as [LAN], [dlna] or [combined program] that enables access to the recorded program list managing module (combined recorded program list creating module) 17 which retains the “combined recorded program list”, that is, an icon (or a button, hereinafter referred to as a network access icon) 311 is displayed.

If the user touches the network access icon 311 or if the user makes access by, for example, the icon 311, the names of the recorders as well as the reproducers or recording/reproducing devices retaining the programs merged in the “combined recorded program list” shown by way of example in FIG. 12 (under left side (second)), or icons or pictograms (signs at the heads of the indications 1012 to 1018 in FIG. 10) are displayed.

Furthermore, for example, the recorder <3>130 (see FIG. 1) is selected. Then, as shown by way of example in FIG. 12 (under right side (third)), a ‘filtered “combined recorded program list”’ 321 that can be reproduced (received) by the recorder <3> is displayed in accordance with the filtering described with reference to FIG. 8, FIG. 9A, and FIG. 9B. It goes without saying that when the list cannot be displayed in a single screen, an “arrow button (icon)”, for example, indicating two directions (a feed (forward) direction and a backward (reveres) direction) is displayed in the same screen to show that the display can be scrolled.

It also goes without saying that the display varies according to the smartphone used and has arrangements and functions that can be classified by manufacturers (supply sources).

Basically, how to display, that is, each “display” varies in its entire length depending on, for example, the number of characters to be displayed. However, it goes without saying that when the number of characters is large, a given display method can be used, for example, a method (display method) whereby a character string is sequentially moved from the head to end within a displayable range by scrolling within the display region called [ticker].

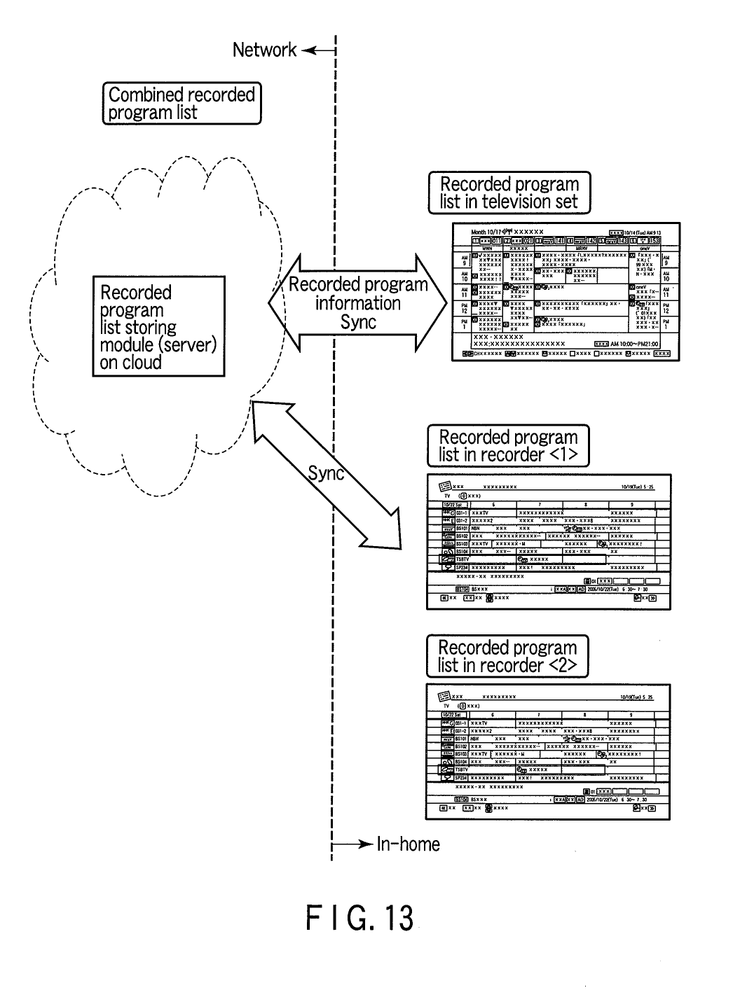

In addition, as shown in FIG. 13, the “recorded program list retaining section (server)” prepared on the network (Internet/cloud computing) can be used instead of the “iCalendar” described with reference to FIG. 6, FIG. 7A, and FIG. 7B.

As described above, according to the present embodiment, the programs independently recorded by two or more recorders can be reproduced by (distributed to) the reproducer to reflect the reproducing capability and operation state of the reproducer or to reflect conditions for reproducing by a device different from the device used for recording that conform to particular classifications of the programs.

Consequently, for a user owning two or more recorders, convenience is improved in reproducing a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording management system comprising:
a retaining module configured to independently retain, in each of a first and second recorder, information on a program recorded by the first recorder and information on a program recorded by the second recorder independent of the first recorder, respectively;
a list creating module configured to create a combined recorded program list, the combined recorded program list comprising a combination of the information on the program recorded by the first recorder and the information on the program recorded by the second recorder that is retained by the retaining module; and
a managing module configured to:
receive, from a reproducer, a request for a list of the programs reproducible by the reproducer;
create, from the combined recorded program list, the list of programs that are reproducible by a reproducer; and
send the list of programs to the reproducer.

2. The recording management system of claim 1, wherein the managing module is configured to create the list of the programs reproducible by the reproducer based on at least one of an operation state of the reproducer, a recording mode and a format that allow reproduction by the reproducer, and reproduction permission conditions specific to the programs.

3. The recording management system of claim 2, wherein the managing module is configured to create the list of the programs reproducible by the reproducer based on a condition in which the reproduction of the programs does not influence the operation of the reproducer.

4. The recording management system of claim 2, wherein the managing module is configured to create the list of the programs reproducible by the reproducer based on restriction information specific to the programs.

5. The recording management system of claim 3, wherein the managing module is configured to create the list of the programs reproducible by the reproducer based on whether the reproducer is available to reproduce the programs or whether a reproduction-ready state can be set.

6. The recording management system of claim 4, wherein the managing module is configured to create the list of the programs reproducible by the reproducer based on whether the reproducer is available to reproduce the programs or whether a reproduction-ready state can be set.

7. The recording management system of claim 1, wherein the managing module is configured to provide access, through a network, to the first recorder, the second recorder, and a terminal device different from the reproducer, and to accept an instruction to the reproducer.

8. A method of generating a program list, the method comprising:
receiving, from a first recorder, information about a video recorded by the first recorder, the first recorder having a format incompatible with a player;
receiving, from a second recorder, information about the video recorded by a second recorder, the second recorder having a format compatible with the player;
receiving, from the player, a request for a list of compatible video recordings; and
sending, to the player, the information about the video recorded by the second recorder.

9. The program recorder of claim 8, further comprising receiving an instruction to modify the video recorded by the first recorder and relaying the instruction to the first recorder.

10. A program recording management method comprising:
retaining information on a program retained by a first recording medium and retaining information on a program retained by a second recording medium independent of the first recording medium, in association with the first and second recording medium, respectively;
combining the program information retained by the first and second recording media; and
changing the combined program information in accordance with a reproduction request such that the combined program information can be checked.

11. The program recording management method of claim 10, further comprising receiving an instruction to change the combined information in response to the reproduction request through a network.

12. The program recording managing method of claim 11, further comprising receiving the instruction to change the combined information in response to the reproduction request from an instruction terminal different from the first and second recording media.
